(19) United States
(12) Patent Application Publication
(10) Pub. No.: US 2024/0052814 A1
(43) Pub. Date: Feb. 15, 2024

(54) Adjustably Counterweighted Barbell Interchangeable Dual Directional Ratchet Gear Energy Generating Physical Exercise Machine

(71) Applicant: Brock Tyler Horstman, Salem, OH (US)

(72) Inventor: Brock Tyler Horstman, Salem, OH (US)

(21) Appl. No.: 18/484,183

(22) Filed: Oct. 10, 2023

(51) Int. Cl. F03G 5/06; A63B 21/072; A63B 21/00; F03G 5/00

(52) U.S. Cl. CPC F03G 5/065; A63B 21/0724; A63B 21/154; F03G 5/086

(57) ABSTRACT

An energy generating physical exercise machine that generates energy from exercise machine's guiderail's user generated movements that turns over one or more dual directional ratchet gear systems that turns over said axles which turn over one or more alternator generators which connect to and charge one or more battery banks in one or more child proof battery bank compartments for energetic storage and usage via transferal by one or more power converters from D/C to A/C energy and from variable voltage levels to regulated and predetermined voltages such as standard household and industrial Voltage levels of 110V A/C, 220V A/C for usage of said power from one or more external plug-in panel(s).

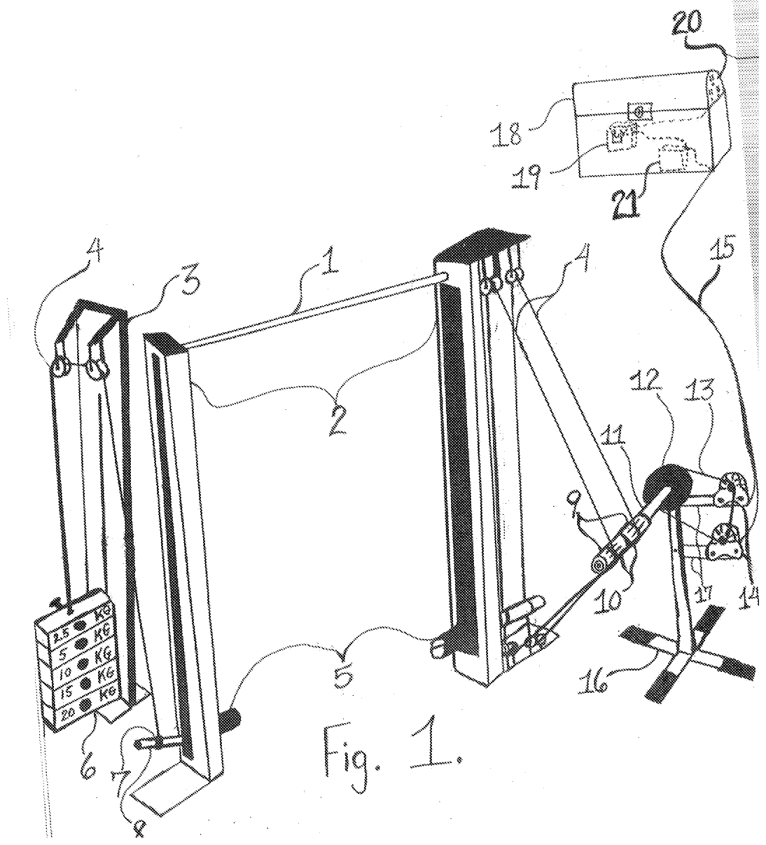

### BACKGROUND—TECHNICAL FIELD

The present invention relates to exercise machinery and energy production, storage, and usage.

### BACKGROUND—PRIOR ART

The present invention details a physical exercise machine, closely related to what is commonly known as a Smith Machine or Physical Exercise Machine that is significantly modified in order to generate energy by its movements via one or more dual directional pulley systems connected to one or more dual directional ratchet gears that turn over one or more axles connected to one or more flywheels that turn over one or more alternator generators that connect by wire to charge one or more batteries in one or more enclosable and child proof battery banks complete with one or more power converters with corresponding external battery bank compartment plug-in panels for a complete renewable home energy power system. This exercise machine also features the use of an adjustably counterweighted pulley system that antagonizes the gravitational pull downward of the barbell when in use which removes the barbell resistance from the users contact point, creating a movement that is essentially bodyweight resisted with only the alternator generator turnover as resistance to be overcome. This counterweight feature creates a high-capacity energy generating exercise machine, charging one or more stored batteries in one or more battery banks inside of one or more enclosable and child proof compartments for household, commercial, and power stationary uses. This is a significant advancement upon the previously patented physical exercise machines already in existence because of said embodiment's capacity to generate electricity from the apparatuses' user-propelled kinetic motions, not to mention it's optimized features described herein.

Said adjustable counter-weighting system de-loads the barbell weight from the user propelling it and thereby encourages higher repetition ranges for faster RPM translated to the axle(s) and subsequent alternator generator(s) turnover, increasing the versatility of said exercise machine through the facilitation of a greater variety of exercises whereby energy generation can occur in said RPM ranges necessary for energy generation with said embodiments use. This greater pool of exercises increases the exercise options with the use of this machine in the anaerobic and aerobic ranges for each exercise, thereby allowing greater energy production from the exercises made possible that would otherwise be impossible without said features application on said embodiment and greater energy production in relation to said system without said feature.

Another feature of said energy generating exercise machine is the implementation of one or more flywheels connecting from one or more rotationally propelled axles of said machine, thereby storing the inertia of the kinetic energy produced, allowing for higher RPM ranges with less effort to keep said RPM range sustainable for extended periods of exercise. Said feature allows for increased power of said system's energy generation overall, and aids the user propelling said machine to fatigue more slowly while retaining elevated RPM ranges at any relative level of exercise intensity compared to said features absence from said embodiment.

Another feature of said energy generating exercise machine is an ability for said machine to change out any standard sized barbell to be used on the guiderails with the use of barbell guiderail attachments. This can be implemented with numerous methods and stylizations of said barbell lock-in mechanisms, of which any would be as useful as another and therefore unbeholden to one mechanism for barbell lock-in than any alternative mechanism, of which no limitation of said mechanism as a feature on said embodiment need be specified, though many mechanizations of said feature are possible and interchangeable.

Additionally, a dual directional ratchet gear system may or may not be used to increase the efficiency and economy of exercise translation to energy production and elevate RPM ranges overall with employment of both upward and downward motions necessary for use of said embodiment. Altogether, this energy generating exercise machine is a significant advancement from previously specified physical exercise machine iterations not only in guided barbell exercise machinery, but also in energy generating exercise machinery. Said features of said significantly innovated machinery is also significantly higher in energy production efficiency and overall production compared to other energy generating exercise machinery as well as the convenience and scope of said embodiment's applications of said energy production.

### BACKGROUND

In the form of high-capacity energy generating exercise machinery, little to no machinery has been considered effective that has yet hit the market. This is primarily a result of a lack of multi-dimensional thinking on the part of exercise machinery innovators and energy generator innovators. As a result, a multi-dimensional energy generating exercise machine such as said embodiment exists as is a modified exercise machine which has been optimized for users to propel said machine at a high RPM for sustained amounts of time in order to consistently and reliably produce enough energy generated and subsequently stored for said machinery's cost to be considered cost-effective and a worthwhile investment to buyers. Until now, this hasn't happened on a wide scale or scope, but with said implementation of said embodiment, this is no longer the case.

The present invention is inspired by the combination of technologies from various fields including automotive style phasic alternators and flywheels, battery bank energy storage compartments, and the concept of modified exercise machinery.

### SUMMARY

In accordance with one embodiment, an exercise machine with a standard size barbell interchangeable attachment connected to guiderails that guide the movement of an attached barbell up and down. An adjustable counterweight feature allows for unloading weight of said bar from user's body while in use to further ease movements of said barbell up and down as featured on said embodiment. Said embodiment features one or more dual directional ratchet gear cranking systems connected by pulley to said exercise machinery that subsequently turn over one or more axles to propel one or more flywheels that retain inertia of said kinetic energy and subsequently turnover one or more belts that turn over one or more alternator generators which connect by electrical wiring which charges batteries in banks of one or more battery enclosable compartments that convert said energy produced by said machine for use directly from said compartment's external plug-in panel on external sides of said compartment's walls for use in charging or powering appliances as well as sending produced energy back through established electrical power grids from home plug-ins. Said embodiment also charges batteries in said battery bank for detached use in various forms like charging batteries for external applications of said batteries for use elsewhere.

### Advantages

Accordingly, notable significant advantages exist with use of said Adjustably Counterweighted, Barbell Interchangeable, Dual Directional Ratchet Gear Energy Generating Exercise Machine and said machines connected battery bank(s) storage compartment(s) with external plug-in panel(s). These advantages include but are not limited to said apparatus' ability to facilitate a higher RPM range for said alternator generators to produce electricity from higher rep ranges to be used by said users and for higher intensities or for users of said machinery to be able to sustain said exercise for longer periods of time, thereby generating significantly more energy through elevated RPM ranges and exercise durations on said embodiment. Additionally, an advantage exists in using this machinery as an energy generating exercise machine whereby the movements, both flexion and extension of the upward and downward propulsions being harnessed by one or more dual directional pulley systems to one or more dual directional ratchet geared systems that harness and turnover the kinetic energy produced from both directionally based movements on said machine for greater energy generation and storage and thereby significantly increased levels of energy available for subsequent use in household or industrially standard ways for user's storage, use, and compensation of their energy in their chosen ways. This allows said users of said embodiment to maximize energy production from exercise that can be utilized in liberating ways for said owners in comparison to other pre-existing renewable energy generating machinery such as solar or wind power energy generators, which are more expensive and less cost inefficient machines since weather cannot be controlled, but an exercise regimen can. Said embodiment is also significantly more advantageous in comparison to pre-existing energy generating exercise machinery for the collective reasons previously stated and their mechanical leverages and increased efficiencies such as usage of flywheels in retaining higher RPM ranges more easily, with a dual directional ratchet gear which retains higher RPM ranges more easily, and counterweighting of said machinery's load which allows for retaining higher RPM ranges more easily. Synergistically, these advantages amplify said embodiment to be highly feasibly in many settings and for many applications dually in terms of physical exercise and the impetus to perform said work, as well as energy generation production thereby usage of said energy in significantly more versatile ways.

### DRAWINGS—REFERENCE NUMERALS

1. Connecting Crossbar
2. Guiderails
3. Counterweighting Stand
4. Cable Pulleys
5. Barbell Guiderail Attachment
6. Adjustable Counterweighting Mechanism
7. Counterweight Pulley Attachment
8. Barbell Guiderail Counterweight Attachment
9. Dual Directional Ratchet Gear Cable Tethering
10. Dual Directional Ratchet Gears
11. Axle
12. Flywheel
13. Flywheel Belt
14. Alternator Generators
15. Alternator Generator Power Cords
16. Flywheel Stand
17. Flywheel Stand Brackets
18. Child Proof Enclosable Battery Bank Compartment
19. Battery Bank D/C to A/C and Voltage Regulating Power Converter
20. Battery Bank External Wall Plug-In Panel
21. Battery Inside Battery Bank Compartment

### DETAILED DESCRIPTION

In accordance with one embodiment, an energy generating physical exercise machine characterized by guiderails attaching any standard size barbells and directing said barbells in vertical motions propelling both upward and downward movements by users of said embodiment as various exercises on it are performed. The interchangeable barbell guiderail attachments add a new level of versatility to the non-energy generating physical exercise machinery already in existence by making said embodiment more affordable at market in comparison to its predecessors, since said barbell is not necessarily included in the sale of said machine in order to be more cost effective, though it may be included, as well.

Said energy generating exercise machine is designed not necessarily for high loads of weight but for enabling the continuous power production of elevated RPM turnover with potential for added use of a gearing system for added resistance translating to higher RPM's in order to maximize cardiovascular exercise in tandem with significantly higher energy production. As a result, the added novel feature of an adjustable counterweight attachment on one or both sides of said machine allows the barbell weight to be offset and therefore de-loads the barbell weight from the user's shoulders while exercising on said embodiment. This novel feature's effect creates a higher energy generating capacity for users as well as an ability for users to endure longer energy generating exercise sessions to maximize energy production.

An additional novel feature of said energy generating exercise machinery comes from the dual-directional ratchet gear system which is connected by dual directional pulleys to said exercise portion of said machinery thereby designed to turn over one or more axles connecting to and turning over one or more flywheels that connect by belt to one or more alternator generators which turn over and generate electricity that is connected by wire from said alternator generators and transmitted thereby to a battery bank enclosed in a child proof battery bank compartment for storage and conversion by a power converter in said compartment to usable energy through one or more standard household plug-ins on one or more external panels on said compartment's external wall(s). Said dual directional ratchet gear system feature is added to create turnover from both upward motions and downward motions from said barbell guided exercise machine apparatus for more efficient exercise economy and significantly higher energy generation. This additional capability allows said mechanism to create and sustain significantly higher RPM's than would otherwise be achievable without it at any given exercise intensity. As a result, this feature allows this machine to be up to twice as effective as either directional motion being harnessed by itself, and enhances the novelty and efficiency of the cardiovascular conditioning effect of the exercises performed on it.

Said electricity produced by said alternator generator(s) is then transferred by battery wire(s) from said alternator generator(s) to one or more batteries in one or more battery banks in one or more childproof battery shelving compartments for power storage and subsequent power usage. Said battery compartment(s) feature a Direct Current to Alternating Current Power Converter with voltage conversion to 110 Volt and/or 220 Volt levels, or any other predetermined voltage settings. Said battery bank compartment(s) feature one or more external electrical plug-in panels on said external battery shelving compartment walls to use said harnessed energy as 110 Volt and/or 220 Volt Direct Current and Alternating Current electrical supply for use in various ways as can be found in standard 110 Volt and/or 220 Volt household electrical plug-in panels on said battery bank compartment's external walls.

### CONCLUSION, RAMIFICATIONS, AND SCOPE

Accordingly, the reader will understand that said adjustably counterweighted, barbell interchangeable, and dual directional ratchet geared energy generating exercise machine allows the user to produce energy with usage of said machine to be stored and/or used as determined by said machine's owner. Any amount of energy produced on said machine is maximized by an energy harnessing system that combines one or more alternators to charge one or more battery banks that store and redistribute produced electrical power into and from a child proof and ventilated enclosable battery bank compartment for subsequent use. Power production is significantly increased with incorporation of one or more flywheels to retain inertia, an adjustable counterweight feature to offset said barbell's weighted resistance while in use, and dual directional ratchet gear mechanism that cranks axle turnover in both directions of up and down on the guiderails thereby maximizing propulsive axial turnover and therefore energy generation and storage by said exercise machine. Furthermore, the adjustably counterweighted, barbell interchangeable and dual directional ratchet geared Energy Harnessing Exercise Machine has all following additional advantages:
It permits use of any preferred standard size barbell by user and thereby decreases upfront cost and increases versatility of exercises which can be performed on said exercise apparatus
It increases energy production with dual directional ratchet gearing to turn over said axle(s) with both upward and downward motions to keep said machine's RPM elevated and therefore allows users to exercise in a more efficient way with relatively greater concurrent energy production from any relative intensity of work performed without such feature
It increases economy of exercise by featuring an adjustable counterweighting system to the barbell to unload the barbell weight from users point(s) of contact, allowing for an aerobic workout instead of an anaerobic workout, or a less intense workload overall while maintaining or increasing the energy produced and the RPMs maintained, or elevated RPm ranges to be sustained for longer periods of exercise

Thus, the scope of the embodiments should be determined by the appended claims and their legal equivalents, rather than by the examples given.

1. An energy generating physical exercise machine.

2. A physical exercise machine characterized by upright, sliding guiderails with barbell interchangeable attachment connected by one more dual directional cable and pulley propulsive systems to proprietary energy generating systems comprising alternator generators and the transmittal of said alternator generator charges into a compartmentalized battery bank for subsequent usage.

3. A pulley and cable based adjustably counterweighted feature for increased economy of movement and energy generation by removing barbell weighted resistance from said exercises vertical up and down movements.

4. One or more dual directional ratchet gear propulsion systems which turn over one or more axles to sustain elevated RPM ranges at any proportional exercise intensity.

5. One or more flywheels connecting axial turnover to one or more belts which subsequently turn over said alternator generators to maintain higher RPM ranges of said propelled axles at relatively lower intensities of exercise by users of said embodiment.

6. One or more energy harnessing apparatuses propelled from said exercise machinery that revolves one or more flywheels with said flywheels connecting one or more alternator generators by one or more belts fixed in place by bracketing and connected by wiring from said one or more alternator generators to one or more batteries in one or more enclosable, child safe battery bank compartments, with or without one or more Direct Current to Alternating Current and voltage regulating power converter boxes affixed inside said battery compartment(s), with battery wires connecting said machinery and external panel plug-ins for readily available 110 Volt A/C and 220 Volt A/C or other predetermined energy level(s) for household and/or industrial use.
